(19) United States
(12) Patent Application Publication
(10) Pub. No.: US 2014/0268864 A1
(43) Pub. Date: Sep. 18, 2014

(54) MODULAR WAVEGUIDE LIGHT FIXTURE

(71) Applicant: Radast Design LLC, Las Vegas, NV (US)

(72) Inventors: David Lee, San Diego, CA (US); Rajvikram Singh, San Diego, CA (US); Steven Thomas Peltier, San Diego, CA (US)

(73) Assignee: Radast Design LLC, Las Vegas, NV (US)

(21) Appl. No.: 14/210,142

(22) Filed: Mar. 13, 2014

Related U.S. Application Data
(60) Provisional application No. 61/786,075, filed on Mar. 14, 2013.
(60) Provisional application No. 61/786,063, filed on Mar. 14, 2013.

(51) Int. Cl. F21V 8/00

(52) U.S. Cl. CPC G02B 6/0096
USPC 362/558

(57) ABSTRACT

Systems and methods for constructing a modular waveguide light fixture are described herein. One aspect of the subject matter described in the disclosure is an apparatus for providing lighting. The apparatus can include a base including a body surrounding a cavity. The apparatus can include a light source disposed within the cavity and configured to emit light. The apparatus can include a waveguide extending from a proximal end to a distal end along a central axis and comprising a core surrounded by an outer surface along the central axis. The proximal end can be configured to interface with and receive the light from the light source. The waveguide can be configured to propagate light within the core via total internal reflection within the outer surface of the waveguide. The apparatus can include a diffusion zone disposed along a portion of the outer surface. The diffusion zone can diffuse the light reaching the diffusion zone based on frustrating the total internal reflection of the light reaching the diffusion zone.

### CROSS REFERENCE TO RELATED APPLICATIONS

This application claims the benefit of U.S. Provisional Patent Application No. 61/786,063, entitled “Waveguide Light Fixture,” filed Mar. 14, 2013 and U.S. Provisional Patent Application No. 61/786,075, entitled “Modular Waveguide Light Fixture,” filed Mar. 14, 2013, each of which is expressly incorporated by reference in its entirety herein.

### FIELD

The present invention generally relates to light fixtures, and more particularly to a light fixture with an integrated waveguide.

### BACKGROUND

Traditionally, a light fixture is a device used to generate light from the flow of electric current across a light source. A light source can emit electromagnetic radiation in the visible spectrum, allowing for the illumination of an environment surrounding the light source. One type of light source is an incandescent light source that runs an electric current through a filament wire to a high temperature. Light can be generated incandescently from the filament due to the high temperature of the filament wire.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described in the disclosure is an apparatus for providing lighting. The apparatus can include a base including a body surrounding a cavity. The apparatus can include a light source disposed within the cavity and configured to emit light. The apparatus can include a waveguide extending from a proximal end to a distal end along a central axis and including a core surrounded by an outer surface along the central axis. The proximal end can be configured to interface with and receive the light from the light source. The waveguide can be configured to propagate light within the core via total internal reflection within the outer surface of the waveguide. The apparatus can include a diffusion zone disposed along a portion of the outer surface. The diffusion zone can diffuse the light reaching the diffusion zone based on frustrating the total internal reflection of the light reaching the diffusion zone.

In another aspect, the diffusion zone frustrates the total internal reflection of the light reaching the diffusion zone based on causing the light to be incident upon the outer surface at an angle smaller than a critical angle with respect to a normal of the outer surface.

In another aspect, the outer surface at the diffusion zone is textured.

In another aspect, the apparatus includes a diffuser slidably coupled with the waveguide, wherein the diffusion zone is located along a surface of the diffuser.

In another aspect, the diffusion zone is disposed along a portion of the outer surface at the distal end of the waveguide.

Another aspect of the subject matter described in the disclosure is an apparatus including a light source that emits light. The apparatus can include a waveguide extending from a proximal end to a distal end along a central axis and including an outer surface. The proximal end can be configured to interface with and receive the light from the light source. The waveguide can be configured to propagate light from the proximal end to the distal end via total internal reflection within the outer surface of the waveguide. The apparatus can include a diffusion zone disposed along a portion of the outer surface. The diffusion zone can diffuse the light reaching the diffusion zone based on frustrating the total internal reflection of the light reaching the diffusion zone.

In another aspect, the diffusion zone frustrates the total internal reflection of the light reaching the diffusion zone based on causing the light to be incident upon the outer surface at an angle smaller than a critical angle with respect to a normal of the outer surface.

In another aspect, the outer surface at the diffusion zone is textured.

In another aspect, the apparatus includes a diffuser slidably coupled with the waveguide, wherein the diffusion zone is located along a surface of the diffuser.

In another aspect, the diffuser is a capped diffuser configured to eliminate light interference patterns in the light diffused from the diffusion zone.

In another aspect, the outer surface of the waveguide includes multiple layers, each layer located at a different distance from the central axis.

In another aspect, the apparatus includes a base including a body surrounding a cavity, wherein the light source is disposed within the cavity.

In another aspect, the base includes a heat sink disposed within the cavity coupled to the light source, wherein the heat sink is configured to transfer heat away from the light source.

In another aspect, the base includes a heat shield disposed along an upper surface of the body to enclose the cavity.

In another aspect, the heat sink is adjacent to the light source and includes at least one channel that runs through the heat sink.

In another aspect, the heat sink includes a plurality of elongated cooling fin structures.

In another aspect, the base surrounds an air gap, wherein the air gap is adjacent to the heat sink between the base and the heat sink.

In another aspect, the waveguide is configured to displace the diffusion zone from heat generated by the light source.

Another aspect of the subject matter described in the disclosure is an apparatus for providing lighting. The apparatus can include means for emitting light. The apparatus can include means for transporting light received from the means for emitting light. The apparatus can include means for diffusing light transported by the means for transporting light based upon frustrating total internal reflection within the means for transporting light.

In another aspect, the means for diffusing light includes a textured surface constructed to frustrate total internal reflection of the light transported by the means for transporting light based on causing the light to be incident upon an outer surface of the means for transporting light at an angle smaller than a critical angle with respect to a normal of the outer surface.

### BRIEF DESCRIPTION OF THE DRAWINGS

FIG. 1A is an exploded view diagram of a modular waveguide light fixture in accordance with one embodiment.

FIG. 1B is a cross-sectional diagram of the modular waveguide light fixture in accordance with one embodiment.

FIG. 2 is an exploded view diagram of the modular waveguide light fixture with a layered waveguide in accordance with one embodiment.

FIG. 3A is a cross-sectional diagram of a base of the modular waveguide light fixture in accordance with one embodiment.

FIG. 3B is a cross-sectional diagram of a base of the modular waveguide light fixture with a layered waveguide in accordance with one embodiment.

FIG. 4A is a cross-sectional diagram of the modular waveguide light fixture with a shade diffuser in accordance with one embodiment.

FIG. 4B is a drawing of the modular waveguide light fixture with a drum shaped shade diffuser in accordance with one embodiment.

FIG. 5 is a cross-sectional diagram of the modular waveguide light fixture with a capped diffuser in accordance with one embodiment.

FIG. 6 is a cross-sectional diagram of the modular waveguide light fixture with multiple waveguides sharing a diffuser in accordance with one embodiment.

FIG. 7 is a cross-sectional diagram of the modular waveguide light fixture with multiple waveguides in accordance with one embodiment.

FIG. 8 is a cross-sectional diagram of the modular waveguide light fixture with multiple diffusion zones in accordance with one embodiment.

FIG. 9 is a cross-sectional diagram of the modular waveguide light fixture with a single waveguide with three ends in accordance with one embodiment.

FIG. 10 is a cross-sectional diagram of the modular waveguide light fixture as a curved modular waveguide light fixture in accordance with one embodiment.

### DETAILED DESCRIPTION

Turning now to the drawings, systems and methods for constructing a modular waveguide light fixture are illustrated. In certain embodiments, the modular waveguide light fixture can radiate or emit light along an outer surface of a waveguide. The light can be generated by a light source disposed within a base of the modular waveguide light fixture. The light generated by the light source can be in an illuminating relationship by being received by a waveguide at a proximal end of the waveguide. The waveguide can include a core in which the light can travel/propagate through the waveguide to the distal end of the waveguide. The light can travel according to the principles of total internal reflection through the waveguide by reflecting within the waveguide upon reaching the interface/outer surface between the waveguide material and external medium. The principles of total internal reflection describes how light, traveling as a light wave, can reflect off and not pass through the outer surface of the waveguide when a traveling light wave is incident on the outer surface at an angle larger than a critical angle with respect to the normal of the outer surface when the refractive index of the waveguide is higher than the refractive index of the medium surrounding the outer surface.

In select embodiments, the waveguide is constructed with a higher refractive index than a medium that surrounds the outer surface of the waveguide, such as but not limited to a gas or another optically clear material. In related aspects, a certain amount of light that propagates through the waveguide can escape the outer surface of the waveguide due to imperfections along the outer surface of the waveguide. In further related aspects, the waveguide can be constructed with multiple layers that vary in distance from a central axis of the waveguide (that runs from one end of the waveguide to another end of the waveguide). The multiple layers can be constructed for various purposes, including (but not limited to) facilitating the total internal reflection of light within the waveguide, protecting of an internal layer of the waveguide and/or to attenuate the effects of thermal expansion from different materials in the waveguide.

In specific embodiments, the waveguide can include a diffusion zone disposed along the outer surface of the waveguide. The diffusion zone can be constructed to emit more light than along other surfaces of the waveguide. Within the diffusion zone, total internal reflection can be frustrated as traveling light can pass through the outer surface of the waveguide and be emitted from the waveguide (at a diffusion point) as opposed to reflecting back within the waveguide. The term “frustrate” is a broad term and, as used herein, can refer to causing light to be incident upon the outer surface of the waveguide at an angle smaller than a critical angle with respect to the normal of the diffusion point/point of light frustration. In further related aspects, the diffusion zone can frustrate total internal reflection by texturing the outer surface of the waveguide (at the diffusion zone) to present points of light frustration that cause more light to be incident upon the outer surface of the waveguide within the diffusion zone at an angle smaller than a critical angle with respect to the normal of the points of light frustration relative to the outer surface of the waveguide not within the diffusion zone. In further related aspects, the texturing of the surface of the outer surface at the diffusion zone can be varied to achieve different light emission patterns. Although the diffusion zone can be a region in which total internal reflection can be frustrated, the diffusion zone can be constructed in any configuration as appropriate to the requirements of a specific application in accordance with different embodiments. For example, in certain embodiments the diffusion zone can be constructed to emit more light than along other surfaces of the waveguide due to artifacts (such as but not limited to minors) embedded within the waveguide that direct light for emission from the diffusion zone.

In particular embodiments, a diffuser can be slidably coupled with the waveguide. By being slidably coupled with the waveguide, the diffuser can slide into a position or out of the position relative to waveguide. When the diffuser is slid into the position, the outer surface of the waveguide can be extended to the outer surface of the diffuser. Thereby, a diffusion zone can be disposed along an outer surface of the diffuser (which corresponds to the outer surface of the waveguide). Light traveling within the waveguide can travel to the diffusion zone disposed along the outer surface of the diffuser by traveling across a distance between an intermediate surface of the waveguide and an inner surface of the diffuser using an evanescent wave that extends across the distance between the intermediate surface of the waveguide and the inner surface of the diffuser. The evanescent wave can be generated from the light traveling within the waveguide. The diffusion zone disposed along the outer surface of the waveguide (which can also be the outer surface of the diffuser) can be textured to emit light by frustrating total internal reflection at the diffusion zone disposed along the outer surface of the waveguide (which can also be the outer surface of the diffuser).

In certain embodiments, the light source can be any device capable of generating light. In related aspects, the light source is an electrically powered light source such as a light emitting diode (LED) or the like. An LED is a semiconductor light source with a chip of semiconducting material doped with impurities to create a p-n junction where light is emitted based upon the flow of charge carriers within the junction. In further related aspects, other types of electrically powered light sources can be utilized such as but not limited to an incandescent light source or a gas discharge light source that generates light by sending an electrical discharge through an ionized gas. In further related aspects, light generated from the light source can be directed to the waveguide using an optical element, such as but not limited to a lens.

In specific embodiments, a heat sink can be utilized to dissipate heat generated by the light source. The heat sink is a heat exchanger that dissipates heat into a medium (such as but not limited to air) surrounding the heat sink. In related aspects, the heat sink adjacent to the light source can dissipate the heat generated by the light source into air surrounding the heat sink and light source. In further related aspects, the heat sink can be composed of a conducting material to effectuate heat transfer. In further related aspects, the heat sink can be in a physical configuration to effectuate heat transfer such as but not limited to by including a channel that runs through the heat sink, elongated cooling fin structures or air gaps adjacent to the heat sink. In further related aspects, the heat sink and light source are enclosed as part of the base of the modular waveguide light fixture. In further related embodiments the heat sink can be in a physical configuration as to support the waveguide or other lamp components.

Various components of a modular waveguide light fixture are discussed below.

### Modular Waveguide Light Fixture Architecture

Modular waveguide light fixtures in accordance with certain embodiments can be configured to emit light received from a light source using the waveguide. An exploded view diagram of the modular waveguide light fixture in accordance with one embodiment is illustrated in FIG. 1A. The exploded view diagram 100 includes the shell 112, light source 108, heat sink 110, heat shield 106, waveguide 104, and diffuser 102. The diffusion zone can be disposed along the outer surface of the diffuser 102 (which can also be the outer surface of the waveguide). Components of the exploded view diagram of FIG. 1A assembled together in a cross-sectional view of the modular waveguide light fixture in accordance with one embodiment is illustrated in FIG. 1B. The cross-sectional view of the fixture 150 illustrates that the base comprises a body surrounding a cavity (illustrated with the space surrounding the heat sink 110). The light source 108 can be disposed within the base and be configured to emit light. The base can position the waveguide 104 relative to the light source 108 to receive light from the light source 108. In related aspects, an optical element can be integrated with or coupled to the light source 108 to facilitate the waveguide's 104 receipt of light emitted from the light source 108. The base also includes a shell 112 and the heat shield 106 which surrounds the cavity between the heat sink 110 and an external region of the base. The light source 108 can be part of an electronics assembly 164 that can include a light switch and electronics that regulates the power provided to the light source from a power source. The waveguide can extend from the proximal end 166 to the distal end 168 along a central axis. The waveguide 104 can also comprise a core surrounded by an outer surface along the central axis. The proximal end 166 of the waveguide 104 can be configured to interface with and receive the light from the light source 108. The light can travel within the core via total internal reflection within the waveguide 104 upon reaching the outer surface. The diffuser 102 can be slidably coupled with the waveguide 104. The diffusion zone can be disposed along a portion of the outer surface of the diffuser. The diffusion zone can diffuse the light reaching the diffusion zone based on frustrating total internal reflection of the light reaching the diffusion zone 102.

FIG. 2 is an exploded view diagram of the modular waveguide light fixture with a layered waveguide in accordance with one embodiment. The exploded view diagram 200 includes a floor plate 226, heat exchange chassis 210, shell 212, diffuser 202, shade retention ring 240, o-rings 242, heat shield 206, shroud 230, optically clear flange 228 and reflective film 218 (such as, for example, but not limited to aluminized Mylar or the like). The floor plate 226, heat exchange chassis 210, shell 212, heat shield 206, shroud 230, optically clear flange 228 and reflective film 218 can be used to form the base. The base can be used to orient the light source 208 relative to the waveguide that includes an inner layer 220 and an outer layer 222 (such as but not limited to an outer cladding layer). The inner layer 220 can be closer to a central axis of the waveguide (that runs from the proximal end of the waveguide to the distal end of the waveguide) than the outer layer 222. A retaining shaft collar 224 can be placed on the outer surface of the waveguide and can orient the diffuser 226 along the diffusion zone of the waveguide.

Although specific architectures for modular waveguide light fixtures are discussed above, modular waveguide light fixture can be constructed in any configuration as appropriate to the requirements of a specific application in accordance with different embodiments. Waveguides in accordance with different embodiments are described further below.

### Waveguides

In certain embodiments, the waveguide can be a structure that guides the direction at which traveling waves of light travel within the waveguide using the principles of total internal reflection. In related aspects, the waveguide can be located between the light source and the diffusion zone, thereby displacing the light source (along with the associated heat generated by the light source) away from the diffusion zone. In further related aspects, the waveguide can be constructed of a material that enables light incident upon one end of the waveguide (the proximal end of the waveguide) to travel through the waveguide to another end of the waveguide (the distal end of the waveguide) where the directed light can escape the outer surface of the waveguide. In further related aspects, the material can be an optically clear material with a higher refractive index than a medium surrounding the material, such as but not limited to acrylic, polycarbonate, or glass. In further related aspects, the waveguide can be a rod with a circular or polygonal cross section.

In particular embodiments, the modular waveguide light fixture can be constructed with a variety of waveguide configurations. In related aspects, the modular waveguide light fixture can include at least one light source oriented to emit light that is received by at least one waveguide, where each waveguide can include at least one diffusion zone. In further related aspects, waveguides of the modular waveguide light fixture can be constructed with any physical shape, including but not limited to linear shapes (such as but not limited to a straight waveguide), non-linear shapes (such as but not limited to waveguides with various curvatures) and shapes with various cross-sections (such as but not limited to a circular, polygonal cross section or combination thereof).

In specific embodiments, the waveguide can be used as a load bearing structural element. The waveguide used as a load bearing structural element can be used with other load bearing structures (such as but not limited to being used as legs on a table) or as a primary load bearing structure, such as but not limited to as an outdoor patio umbrella by incorporating a straight waveguide that serves the dual purpose of radiating light and serving as a pole upon which an umbrella canopy is attached.

In particular embodiments, the waveguide can be constructed with a single or multiple layers that vary in distance from the central axis of the waveguide. In related aspects, the waveguide can include an inner layer (surrounding a core) that functions as an inner core channel layer with a surrounding layer that functions as an outer cladding layer for the inner core channel layer. In related aspects, the outer cladding layer can have a lower refractive index relative to the refractive index of the inner layer to facilitate the reflection of light waves back into the inner layer upon reaching the interface between the outer cladding layer and the inner layer in accordance with the principles of total internal reflection. In further related aspects, a layer can sit between other layers to provide support for the surrounding layers and/or to facilitate the reflection of light back into an inner layer in accordance with the principles of total internal reflection, such as but not limited to a layer of air that sits between an inner layer and an outer layer. In further related aspects, an intermediate layer of air can buffer the effects of thermal expansion of the inner and outer layer relative to the intermediate layer of air to yield a more robust waveguide. In further related aspects, the intermediate layer of air can also provide a medium upon which total internal reflection can occur to reflect light back into the inner layer due to the lower refractive index of the intermediate layer of air relative to the inner layer. In further related aspects, the inner layer can be made of a material conducive to the transmission of light, such as but not limited to acrylic, polycarbonate, or glass. In further related aspects, the outer layer can be constructed of a material that is abrasion resistant and/or impact resistant. In a number of embodiments, a waveguide can be surrounded by a transparent sheath that can protect the waveguide from exposure. The transparent sheath can also be configured to enhance the aesthetics of the modular waveguide light fixture.

In specific embodiments, the diffusion zone of the waveguide is a section of the outer surface of the waveguide constructed to emit more light than along other sections of the outer surface of the waveguide. In related aspects, a single waveguide includes a single diffusion zone. In further related aspects, a single waveguide can include no diffusion zones. In further related aspects, a single waveguide can include multiple diffusion zones. In further related aspects, a single waveguide with a single or multiple diffusion zones can receive light emitted from multiple light sources. In further related aspects, multiple waveguides can share a same diffusion zone. In further related aspects, various diffusion zones of the waveguide with multiple diffusion zones can be constructed differently to provide flexibility in the location and/or emission of light from the diffusion zones.

In select embodiments, the diffusion zone is implemented by texturing the outer surface of the waveguide at the diffusion zone. The textured outer surface can frustrate total internal reflection through points of light frustration that cause more light to escape due to being incident upon the outer surface of the waveguide at an angle smaller than a critical angle with respect to the normal of the points of light frustration. In related aspects, the diffusion zone can be implemented by locating the diffuser along the diffusion zone of the waveguide. In further related aspects, the diffuser can be located along the diffusion zone with a higher refractive index than the medium surrounding the waveguide within a distance from the waveguide of the order of a wavelength of a light wave propagating within the waveguide in order to frustrate the total internal reflection within the waveguide at the diffusion zone. In further related aspects, the outer surface of the diffuser is textured to frustrate total internal reflection within the diffuser through points of light frustration that cause more light to escape due to being incident upon the outer surface of the diffuser at an angle smaller than a critical angle with respect to the normal of the points of light frustration. In further related aspects, both the outer surface of the waveguide at the diffusion zone and the inner surface of the diffuser slidably coupled to the intermediate surface of the waveguide are textured. In further related aspects, texturing of the outer surface of a waveguide or a diffuser at a diffusion zone can be made to achieve a certain effect from the light emitted from the diffusion zone.

In specific embodiments, imperfections along the outer surface of the waveguide can be managed by managing a level of surface uniformity (polish) along the outer surface of the waveguide. Achieving a greater level of surface uniformity can be correlated to a lower amount of imperfection along the outer surface of the waveguide. Different surfaces of the waveguide can be subject to different levels of surface uniformity, such as (but not limited to) where the diffusion zone can have a lower level of surface uniformity than the outer surface of the waveguide not along the diffusion zone. Also, in related aspects, the entire outer surface of a waveguide can enjoy a high level of surface uniformity.

In additional embodiments, waveguides can be designed to vary the effectiveness of the waveguide in capturing light emitted by the light source or diffusing light from the diffusion zone. In related aspects, surface uniformity of the waveguide can be varied to affect the effectiveness of the waveguide in capturing light emitted by the light source or diffusing light from the diffusion zone. For example, the surface uniformity of the proximal and distal ends can affect the efficiency of the coupling of the waveguide and light source and/or transmissive efficiency of the waveguide. Also, distorted surfaces on the proximal and distal ends can cause light to reflect back to the LED, or back within the waveguide. Distorted surfaces along the waveguide can also act as points of light frustration. In further related aspects, the distance between the waveguide and the light source can be varied to change the effectiveness of the waveguide in capturing light emitted by the light source or diffusing light from the diffusion zone. For example, minimizing the distance between the proximal end of the waveguide (the end of the waveguide for light collection/entry surface) and the light source can increase the amount of light entering the waveguide. In further related aspects, varying the size of a part of the light source that emits light relative to the proximal end of the waveguide can affect the effectiveness of the waveguide in capturing light emitted by the light source or diffusing light from the diffusion zone. In further related aspects, varying the size, ratio, and attributes of the diffusion zone can affect the efficiency of the waveguide in capturing light emitted by the light source or diffusing light from the diffusion zone. In further related aspects, the quality and properties of materials used for the waveguide can be varied to affect the effectiveness of the waveguide in capturing light emitted by the light source or diffusing light from the diffusion zone. For example, internal clarity of the waveguide and surface uniformity can affect the amount of light scattered along the length of the waveguide. Also, varying material used for the waveguide can vary color shifts or the effectiveness of the waveguide in capturing light emitted by the light source or diffusing light from the diffusion zone.

In certain embodiments, the diffuser can be implemented as an object that covers an intermediate surface of the waveguide. In related aspects, the diffuser can be implemented as a tube that can envelop the intermediate surface of a cylindrical waveguide. In further related aspects, the diffuser can be slidably coupled to the waveguide such that the diffuser can slide onto and off of the intermediate surface of the waveguide. In further related aspects, the diffuser can extend past an end of the waveguide to achieve a certain emission of light from the surface of the diffuser and/or waveguide. In further related aspects, the diffuser can be implemented as a capped diffuser with a cap that encloses one end of the diffuser. The cap of the capped diffuser can rest on an end of the waveguide or rest in a position that does not contact an end of the waveguide. In further related aspects, the diffuser can be mounted to the waveguide with adhesives or a mechanical mount, such as but not limited to being press fit to the waveguide. In further related aspects, the diffuser can be mechanically displaced from the intermediate surface of the waveguide.

Although specific constructions of waveguides for modular waveguide light fixtures are discussed above, waveguides can be constructed in any configuration as appropriate to the requirements of a specific application in accordance with different embodiments. In certain embodiments, the diffusion zone is not required to be present on the waveguide of the modular waveguide light fixture. Modular waveguide light fixture bases in accordance with different embodiments are described further below.

### Modular Waveguide Light Fixture Bases

In select embodiments, the base is a structure that supports integration of the waveguide with the light source. In related aspects, the base can support the integration of a waveguide with the light source by orienting the light source within the base to orient the light source relative to the waveguide. In further related aspects, a portion of the waveguide can function as the base by providing a physical structure that aids in orienting the light source relative to the waveguide. In further related aspects, the base can orient the light source relative to the waveguide by orienting the waveguide to be as close as possible to the light source (such as, but not limited to by having the wave guide in contact with the light source or integrated with the light source).

In particular embodiments, the base can include a heat sink and/or an air gap that allows convective airflow within the base to dissipate heat generated by the light source. In related aspects, the heat sink can be implemented as a conductive piece of metal with integrated fins that dissipate heat generated by the light source. In related aspects, the heat sink can also provide a mechanical coupling that orients the waveguide relative to the light source. In further related aspects, the light source can be adjacent to and/or attached with the heat sink.

In a number of embodiments, the heat shield can be utilized to enclose the base in which the light source is disposed and to provide thermal insulation from the light source. In further related aspects, the heat shield can be implemented as a perforated sheet of material, such as but not limited to a machined or die cast piece of metal or plastic. In further related aspects, the heat shield is thermally isolated from the heat sink and/or light source using a layer of heat insulating material, such as but not limited to Mylar, ceramic, glass, acrylic, or mica. In further related aspects, the heat shield can be constructed to reflect heat from the light source back into the base so that the exterior surface of the base (including the exterior surface of the heat shield) is cool relative to the interior of the base. A cross-sectional diagram of the base of the modular waveguide light fixture with a heat sink and heat shield in accordance with one embodiment is illustrated in FIG. 3A. The diagram 300 illustrates that the base can be formed with a perforated heat shield 306 and the heat sink 310 with through channels such that the through channels of the heat sink 310 are aligned with the perforations of the heat shield 306, as illustrated with dashed arrows through the base.

In specific embodiments, the base can provide a foundation that supports the structure of the modular waveguide light fixture. In related aspects, the base can be sized to lower the overall center of mass for the modular waveguide light fixture closer to a surface on which the modular waveguide light fixture rests on top of. In further related aspects, the base can be constructed with protrusions from a lower surface of the base to provide a degree of clearance from a surface that the base rests upon. In further related aspects, the base can be integrated with a decorative element, such as a decorative element mounted under the base or around the base. In further related aspects, waveguides of the modular waveguide light fixture need not sit on top of the base but can be oriented in a different configuration relative to the base, such as but not limited to being below the base or to the side of the base.

In specific embodiments, the light source can be part of an electronics assembly that includes facilities that provision power to the light source from the power source. In related aspects, the electronics assembly can include the power switch and electronics that regulate power supplied to the light source. In further related aspects, the power switch can feature a built in dimmer to modulate the brightness of the light source. In further related aspects, the electronics assembly supplies power from an 110v/240v electrical outlet as controlled by the power switch. In further related aspects, the electronics assembly can be rendered water resistant, such as but not limited to by being sealed in water resistant epoxy.

In certain embodiments, the base can be constructed to direct the light emitted from the light source into the waveguide. In related aspects, the base can be constructed to direct light generated by a light source by enclosing the light source in a reflective surface where light is reflected from the reflective surface to enter the waveguide. In further related aspects, heat that is emitted from the light source can also be directed within the base utilizing a reflective surface, such as but not limited to orienting a reflective surface of the base to deflect heat onto the heat sink.

In specific embodiments, the optical element can be utilized to focus light generated by the light source onto the waveguide. In related aspects, the optical element can be constructed to cause light to enter into the waveguide at a particular angle that can enable light to travel within the waveguide under the principles of total internal reflection. In further related aspects, the optical element can be a single optical element, such as but not limited to a single lens. In further related aspects, the optical element can include multiple individual elements, such as but not limited to a lens stack of multiple lenses. In further related aspects, the optical element is integrated with the light source. In further related aspects, the optical element is not included.

A cross-sectional diagram of the base of the modular waveguide light fixture with the layered waveguide and optical element in accordance with one embodiment is illustrated in FIG. 3B. The cross-sectional diagram 350 illustrates that the base can orient the light source 384 relative to the waveguide that includes the inner layer 354, the outer layer (such as but not limited to an outer cladding layer) and the outer surface 352. The light source 384 can be disposed within the base and aligned with the waveguide 354 using the supporting flange 360 mounted to the chassis 366. An optional optical element can be used to direct into the waveguide. The optically clear flange 360 can be bordered by a reflective film 364 (such as but not limited to aluminized Mylar or polyester film) along a surface of the reflective film 364. In further related aspects, the reflective film can be used as part of the heat sink to manage the propagation of heat generated by a light source. In further related aspects, the reflective film can be used to manage the emission of light generated by the light source, such as but not limited to by aiding in directing light to enter the waveguide. A shroud 358 can sit on top of the optically clear flange and along the outer surface of the waveguide to further orient the waveguide relative to the light source 384. The insulating layer 388 and reflective film 364 can be bordered by the heat exchange chassis 366 that can operate as part of a heat sink. The heat exchange chassis 366 can be disposed within a base with a surrounding heat shield 386 oriented along a first surface of the base (such as but not limited to an upper surface), floor plate 380 oriented along a second surface of the base (such as but not limited to a lower surface) and a shell 370 oriented between the first surface and second surface of the base. The floor plate 380 can operate as part of the heat sink by including at least one through channel 382 to permit the flow of air within the base for dissipation of heat within the base. The heat shield 386, shroud 358, optically clear flange 360, reflective film 364, insulating layer 388, heat exchange chassis 366, shell 370 and floor plate 380 can be included as part of a base that orients the light source 384 relative to the waveguide.

Although specific constructions of modular waveguide light fixture bases are discussed above, modular waveguide light fixture bases can be constructed in any configuration as appropriate to the requirements of a specific application in accordance with different embodiments. Modular waveguide light fixtures with shade diffusers in accordance with different embodiments are described further below.

### Shade Diffusers

In a number of embodiments, a shade diffuser can be utilized to diffuse light emitted from a waveguide, such as but not limited to light emitted from a diffusion zone. In related aspects, the shade diffuser can be made of a translucent material, such as but not limited to a fabric, and can be mounted or attached to the waveguide. A cross-sectional diagram of a modular waveguide light fixture with the shade diffuser in accordance with one embodiment is illustrated in FIG. 4. The diagram 400 illustrates that the shade diffuser 420 can be mounted to cover a diffuser 402 by utilizing a mount 422 attached to the waveguide 404. The light source 408 is part of the base which includes the heat sink 410 adjacent to the light source 408 and positions the waveguide 404 relative to the light source 408. The base also includes the shell 412 and the heat shield 406 which provides space between the heat sink 410 and an external region of the base. The light source 408 can be part of an electronics assembly that also includes the light switch and electronics 424 that regulates the power provided to the light source from the power source. A drawing of the modular waveguide light fixture with a drum shaped shade diffuser in accordance with one embodiment is illustrated in FIG. 4B. The drawing 430 illustrates that the modular waveguide light fixture includes the waveguide 404 supported by the base 436 with the drum shaped shade diffuser 432.

Although specific constructions of modular waveguide light fixtures with the shade diffuser are discussed above, modular waveguide light fixtures can be constructed with the shade diffuser in any configuration as appropriate to the requirements of a specific application in accordance with different embodiments. Modular waveguide light fixtures with capped diffusers in accordance with different embodiments are described further below.

### Capped Diffuser

In specific embodiments, the diffuser can be utilized to control the emission of light that passes through the diffuser from the diffusion zone of the waveguide. In controlling the emission of light, the diffuser can interface with the waveguide in any manner, such as (but not limited to) covering a section of the waveguide or extending past a section of the waveguide. FIG. 5 is a cross-sectional diagram of the modular waveguide with a capped diffuser in accordance with one embodiment. The diffuser can be implemented as a capped diffuser 502 with a cap 508 that encloses one end of the diffuser. Thereby, the capped diffuser 502 can control the emission of light that passes from one end of the waveguide through the capped diffuser 502. The capped diffuser 502 can be implemented in a manner where the cap is on a section of the capped diffuser 502 that extends past a section (such as an end) of a waveguide or where the cap is also in contact with a section (such as an end) of the waveguide. The diagram 500 illustrates how the capped diffuser 502 can be slidably coupled with the waveguide 504. The capped diffuser can also extend from an end 506 of the waveguide with the cap 508. A space 510 can be formed between the cap 508 and the end 506 of the waveguide. Thereby, the diffusion zone in the illustrated embodiment covers not only the section of the waveguide in contact with the capped diffuser but also the end 506 of the waveguide (not in contact with the capped diffuser 502) as well. The capped diffuser 502 can be oriented by resting on the retaining shaft collar 512 that sits on the outer surface of the waveguide 504. The retaining shaft collar 512 can also be constructed as a mount on which a shade diffuser can be oriented. In particular embodiments, a capped diffuser can be constructed to modify or eliminate light interference patterns in the light emitted from the waveguide.

In certain embodiments, a transparent sheath 514 can be used to surround and protect the waveguide 504. The transparent sheath 514 can be used to shield the waveguide 504 from contact and/or damage (such as but not limited to from an object hitting the waveguide or from fingerprints accruing on the outer surface of the waveguide). The transparent sheath 514 can also be removable. The transparent sheath 514 can be implemented with a transparent material that surrounds the waveguide. The transparent sheath 514 can be implemented with an air gap 516 between the outer surface of the waveguide 504 and the transparent sheath 514. In one particular embodiment the air gap 516 can be implemented by locating an O-ring seal 518 between the transparent sheath 514 and the waveguide 504.

In particular embodiments, a thermal barrier can be implemented with an insulating spacer ring 520 and flange 522. In related aspects, the flange 522 can be an acrylic offset flange bonded to the waveguide 504. In further related aspects, the flange 522 can allow for precise positioning of the waveguide's distal end relative to the light source and secure the waveguide to the base assembly. In further related aspects, the thermal barrier can include components (not limited to but including a reflective mylar film) to reflect radiant heat from the light source back into the base so that the exterior surface of the lamp is cool relative to the interior of the base.

Although specific constructions of modular waveguide light fixtures with the capped diffuser are discussed above, modular waveguide light fixtures can be constructed with a diffuser in any configuration as appropriate to the requirements of a specific application in accordance with different embodiments. For example, the diffuser need not be the capped diffuser (such as a diffuser that does not enclose one end of the diffuser) in certain embodiments. Various different configurations of a modular waveguide light fixture in accordance with different embodiments are described further below.

### Various Modular Waveguide Light Fixture Configurations

Modular waveguide light fixtures in accordance with certain embodiments can be constructed in various different configurations that separate a location of a diffusion zone along the outer surface of a waveguide from a location of a light source. A cross-sectional diagram of the modular waveguide light fixture with multiple waveguides that share the same diffuser oriented relative to multiple light sources in accordance with one embodiment is illustrated in FIG. 6. The diagram 600 illustrates multiple waveguides 604 with diffusion zones that connect with the shared diffuser 602. Each of the waveguides 604 receives light emitted from different light sources 614. Also, each light source 614 is part of the base which includes a heat sink 612 adjacent to each light source and positions the waveguide 604 relative to each light source 614. The base also includes the shell 608 and the heat shield 606 which provides space between the heat shield 606 and the external region of the base. Each light source 614 can be part of the electronics assembly that also includes a light switch and electronics 616 that regulates the power provided to each light source from the power source. Although construction of a modular waveguide light fixture with multiple waveguides that share a same diffuser is discussed above, modular waveguide light fixtures can be constructed in any configuration, such as but not limited to where a single light source emits light for multiple waveguides (each with at least one diffusion zone) or where a single waveguide with a single diffusion zone can be constructed to receive light emitted from multiple light sources.

A cross-sectional diagram of the modular waveguide light fixture with multiple waveguides in accordance with one embodiment is illustrated in FIG. 7. The diagram 700 illustrates three waveguides 704. Each waveguide 704 receives light emitted from a separate light source 712 at one end of the waveguide and has a different diffusion zone 702 at the other end. Also, each light source is part of a base which includes the heat sink 710 adjacent to each light source 712 and positions each waveguide 704 relative to each light source 712. The base also includes the shell 706 and the heat shield 708 which provides space between the heat shield 708 and the external region of the base. Each light source 712 can be part of the electronics assembly that also includes the light switch and electronics 714 that regulates the power provided to each light source from the power source.

A cross-sectional diagram of the modular waveguide light fixture with multiple diffusion zones in accordance with one embodiment is illustrated in FIG. 8. The diagram 800 illustrates one waveguide 804 receiving light emitted from the light source 812 at one end. The waveguide 804 includes three diffusion zones 802 along different portions of the outer surface of the waveguide 804. The light source 812 is part of the base which includes the heat sink 810 adjacent to the light source 812 and positions the waveguide 804 relative to the light source 812. The base also includes a shell 808 and the heat shield 806 which provides space between the heat shield 806 and the external region of the base. The light source 812 can be part of the electronics assembly 814 that also includes the light switch and electronics that regulates the power provided to the light source from a power source.

A cross-sectional diagram of the modular waveguide light fixture with a single waveguide that includes three ends in accordance with one embodiment is illustrated in FIG. 9. The diagram 900 illustrates that one end of the waveguide 904 receives light emitted from the light source 912. The other two ends of the waveguide 904 terminate in different locations with diffusion zones encompassing each terminating end 902. The light source 912 is part of the base anchored in a ceiling 908 positioned above the waveguide 904 and diffusion zones 902. The base includes a heat sink 910 adjacent to the light source 912 and positions the waveguide 904 relative to the light source 912. The heat shield 906 can sit below the ceiling and offer further protection from the heat generated by the light source 912. The light source 912 can be part of the electronics assembly 914 that also includes the light switch and electronics 912 that regulates the power provided to the light source 912 from a power source.

A cross-sectional diagram of the modular waveguide light fixture as a curved modular waveguide light fixture in accordance with one embodiment is illustrated in FIG. 10. The diagram 1000 illustrates one waveguide 1004 with two ends, where one end receives light emitted from the light source 1012. The waveguide 1004 possess a curved shape that enables the waveguide 1004 to channel light in a curved direction within the limits of total internal reflection. The waveguide 1004 includes the diffusion zone 1002 that encompasses the other end of the waveguide 1004. The light source 1012 is part of a base which includes the heat sink 1010 adjacent to the light source 1012 and positions the waveguide 1004 relative to the light source 1012. The base also includes the shell 1008 and the heat shield 1006 which provides space between the heat shield 1006 and the external region of the base. The light source 1012 can be part of the electronics assembly 1014 that also includes a light switch and electronics that regulates the power provided to the light source from the power source.

Although specific configurations of modular waveguide light fixtures are discussed above, modular waveguide light fixtures can be constructed with any number of waveguides, light sources, diffusion zones, optics, or bases in any configuration that enables the guidance of light to travel from a light source to a diffusion zone through a waveguide as appropriate to the requirements of a specific application in accordance with different embodiments.

Although different embodiments have been described in certain specific aspects, many additional modifications and variations would be apparent to those skilled in the art. It is therefore to be understood that certain embodiments may be practiced otherwise than specifically described, including various changes in the implementation. Thus, these embodiments should be considered in all respects as illustrative and not restrictive.

1. (canceled)

2. An apparatus for providing lighting, comprising:
a base comprising a body surrounding a cavity;
a light source disposed within the cavity and configured to emit light;
a waveguide extending from a proximal end to a distal end along a central axis and comprising a core surrounded by an outer surface along the central axis, the proximal end configured to interface with and receive the light from the light source, the waveguide configured to propagate light within the core via total internal reflection within the outer surface of the waveguide; and
a diffusion zone, disposed along a portion of the outer surface, that diffuses the light reaching the diffusion zone based on frustrating the total internal reflection of the light reaching the diffusion zone.

3. The apparatus of claim 2, wherein the diffusion zone frustrates the total internal reflection of the light reaching the diffusion zone based on causing the light to be incident upon the outer surface at an angle smaller than a critical angle with respect to a normal of the outer surface.

4. The apparatus of claim 3, wherein the outer surface at the diffusion zone is textured.

5. The apparatus of claim 4, further comprising a diffuser slidably coupled with the waveguide, wherein the diffusion zone is located along a surface of the diffuser.

6. The apparatus of claim 4, wherein the diffusion zone is disposed along a portion of the outer surface at the distal end of the waveguide.

7. An apparatus, comprising:
a light source that emits light;
a waveguide extending from a proximal end to a distal end along a central axis and comprising an outer surface, the proximal end configured to interface with and receive the light from the light source, the waveguide configured to propagate light from the proximal end to the distal end via total internal reflection within the outer surface of the waveguide; and
a diffusion zone, disposed along a portion of the outer surface, that diffuses the light reaching the diffusion zone based on frustrating the total internal reflection of the light reaching the diffusion zone.

8. The apparatus of claim 7, wherein the diffusion zone frustrates the total internal reflection of the light reaching the diffusion zone based on causing the light to be incident upon the outer surface at an angle smaller than a critical angle with respect to a normal of the outer surface.

9. The apparatus of claim 8, wherein the outer surface at the diffusion zone is textured.

10. The apparatus of claim 9, further comprising a diffuser slidably coupled with the waveguide, wherein the diffusion zone is located along a surface of the diffuser.

11. The apparatus of claim 10, wherein the diffuser is a capped diffusor configured to eliminate light interference patterns in the light diffused from the diffusion zone.

12. The apparatus of claim 7, wherein the outer surface of the waveguide comprises multiple layers, each layer located at a different distance from the central axis.

13. The apparatus of claim 7, further comprising a base comprising a body surrounding a cavity, wherein the light source is disposed within the cavity.

14. The apparatus of claim 13, wherein the base comprises a heat sink disposed within the cavity coupled to the light source, wherein the heat sink is configured to transfer heat away from the light source.

15. The apparatus of claim 14, wherein the base comprises a heat shield disposed along an upper surface of the body to enclose the cavity.

16. The apparatus of claim 15, wherein the heat sink is adjacent to the light source and includes at least one channel that runs through the heat sink.

17. The apparatus of claim 16, wherein the heat sink comprises a plurality of elongated cooling fin structures.

18. The apparatus of claim 17, wherein the base surrounds an air gap, wherein the air gap is adjacent to the heat sink between the base and the heat sink.

19. The apparatus of claim 18, wherein the waveguide is configured to displace the diffusion zone from heat generated by the light source.

20. An apparatus for providing lighting, comprising:
means for emitting light;
means for transporting light received from the means for emitting light; and
means for diffusing light transported by the means for transporting light based upon frustrating total internal reflection within the means for transporting light.

21. The apparatus of claim 20, wherein the means for diffusing light comprises a textured surface constructed to frustrate total internal reflection of the light transported by the means for transporting light based on causing the light to be incident upon an outer surface of the means for transporting light at an angle smaller than a critical angle with respect to a normal of the outer surface.
